(19) United States
(12) Patent Application Publication
(10) Pub. No.: US 2007/0181611 A1
(43) Pub. Date: Aug. 9, 2007

(54) Pump having a sealing mechanism

(76) Inventors: Santiago Julian Pidevall, Barcelona (ES); Victor Ribera Turro, Barcelona (ES)

Correspondence Address: STAAS & HALSEY LLP, SUITE 700, 1201 NEW YORK AVENUE, N.W., WASHINGTON, DC, 20005, US

(21) Appl. No.: 10/589,194

(22) PCT Filed: Jul. 18, 2005
(86) PCT No.: PCT/ES05/00402

§ 371 Date: Aug. 11, 2006

(30) Foreign Application Priority Data
Oct. 20, 2004 (ES) P200402493

(51) Int. Cl. G01F 11/00

(52) U.S. Cl. 222/409

(57) ABSTRACT

A pump having a sealing mechanism including (a) a main body having a first surface, (b) an attachment body with member to attach to a bottle neck, (c) an inlet valve, (d) a second surface where both surfaces define a pumping chamber, and (e) a discharge valve, where both surfaces are adapted to perform a relative movement therebetween causing the pumping of a liquid. The attachment body is connected to the main body for relative displacement between an open position and a closed position and includes a projection which, when the attachment body and the main body are in the closed position, prevents the second surface from performing the relative movement.

### DESCRIPTION

1. Field of the Invention

The invention relates to a pump having a sealing mechanism, particularly a pump comprising: (a) a main body having a first surface, (b) a attachment body having first means for attachment to a bottle neck, (c) second means for attachment of a dip tube, (d) an inlet valve, (e) a second surface facing said first surface, where said first surface and said second surface define a pumping chamber, and (f) a discharge valve at the outlet of said pumping chamber, where said first surface and said second surface are adapted to perform a relative movement therebetween causing the pumping of a liquid between said inlet valve and said discharge valve.

2. State of the Art

Various embodiments of manually operated pumps of the above mentioned type are known for a plurality of applications, for example metering pumps for all kinds of liquids, such as cosmetics, liquid soaps, etc., spray pumps for eaux de Cologne, perfumes, etc., etc.

A known improvement for these pumps is the inclusion of a sealing mechanism preventing inadvertent operation of a pumping movement with the consequent spilling of liquid during handling, transport, storage, etc., of the pump. One example of embodiment of a sealing mechanism of this type may be seen in Spanish Patent ES P9800915, of the same applicant, published on Feb. 1, 2001.

In other cases, the pumps do not include any type of sealing mechanism, such as for example the one shown in U.S. Pat. No. 3,820,689, published on Jun. 28, 1974.

Such pumps are frequently used on disposable liquid containers. In this sense, the cost of the pump has to be very low, since it must not appreciably affect the product total cost. On the other hand, apart from performing the technical function of pumping the liquid, the pump frequently has to have a particular aesthetic appearance, a fact that often imposes serious geometrical limitations, which have to be compatible with the correct working of the pump. In this sense, there is a permanent need for developing new pumps including a sealing mechanism, allowing for cost savings and limiting as little as possible the aesthetic appearance it is wanted to confer on the pump.

### SUMMARY OF THE INVENTION

The invention aims to overcome these drawbacks. This aim is achieved with a pump of the type first mentioned above wherein the attachment body is attached to the main body with the possibility of a relative displacement between an open position and a closed position and wherein the attachment body comprises a projection which, when the attachment body and the main body are in the closed position, prevents the second surface from performing the relative movement. In this way, it is possible to have a sealing mechanism preventing discharge of liquid by inadvertent pumping, for example during the transportation and handling of the pump. The attachment body is a member (or group of members) attached to the bottle containing the liquid, and the main body is a member (or group of members) capable of effecting a displacement relative to the attachment body, but which is a movement totally unrelated to the movement causing pumping of the liquid. The movement causing pumping of the liquid as a relative movement between the first surface and the second surface, where the first surface is on the main body and where the second surface is on the head or on a member mechanically associated with the head such that when the head (which is the regular actuating system) is moved, there is induced a movement of the second surface. For example, in the case shown in ES P9800915, the second surface is on the piston and/or on the plug member (where the plug member is completely fixedly attached to the head while the piston is mechanically associated with the head, although it may perform a slight relative movement). On the other hand, U.S. Pat. No. 3,820,689 discloses a pump in which the second surface is a direct part of the head, which is elastically deformed during a pumping movement. In any case, in the pump according to the invention, there is no relative movement between the main body and the attachment body during the pumping of the liquid.

On saying that there is relative displacement between the main body and the attachment body, the purpose is to indicate a movement of necessity including a translation, both if it includes a rotary movement (thus forming, for example, a spiral movement) and if it does not include it.

Preferably the projection is a tubular stem surrounding the inlet valve. The projection thus serves also to close the passage of the inlet valve, which also prevents liquid spillages caused by over-pressurizing the container and/or placing it upside down. This is achieved preferably by having the projection hermetically sealed against the second surface when the attachment body and the main body are in the closed position.

Advantageously, the relative displacement is greater than the relative movement. There is thus ensured, on the one hand, that the projection makes contact with the second surface when it is in the closed position and, on the other hand, that the second surface does not contact the projection when the pump is in its open position but when the second surface is in the limit of deformation due to the pumping movement. There may thus be included lips on the second surface improving the seal with the projection when the pump is in the closed position, without running the risk of these lips contacting the projection during a pumping movement, since otherwise the risk would be run of the second surface becoming blocked with the projection and not being able to return to its initial position (extended position).

The main body preferably comprises a first annular lip acting as a seal with the outer wall of the tubular stem.

The main body advantageously comprises a second annular lip acting as a seal with an annular partition disposed in the attachment body when the pump is in the closed position, where the annular partition surrounds a ventilation hole. There are thus avoided possible liquid losses through the ventilation hole.

A further preferred embodiment of the invention is obtained when the pump according to the invention meets the following conditions: (a) it additionally comprises a head, where the head comprises the second surface, where the head is made from a material having elastomeric properties adapted to be elastically deformed by a manually applied force and has an external actuation surface adapted to be deformed by a user's finger, (b) the discharge valve comprises a valve seat and a moving member adapted to move between a first position, corresponding to the closed discharge valve and in which the moving member contacts the valve seat, and a second position, corresponding to the open discharge valve, where the moving member extends from the head forming a partition, where the moving member is integral with said head, and (c) when the moving member is in the first position, and there is a reduced pressure in the pumping chamber, the reduced pressure then exerts a force pressing the moving member against the valve seat.

In fact, in this way it is possible to improve the pumping effect in certain simplified metering pumps. Concretely, with a pump of the type described in U.S. Pat. No. 3,820,689 mentioned above, a good pumping effect is not achieved. This appears to be due to the discharge valve not closing optimally, because when there is a reduced pressure in the pumping chamber, thanks to which it is filled with liquid from the reservoir, the discharge valve is then closed due only to the resilient forces of the head, which is made from a material having elastomeric properties. Nevertheless, the reduced pressure in the pumping chamber tends to open the discharge valve, because the discharge valve has downstream the atmospheric pressure of the external environment, whereby the pressure differential acts against closing of the discharge valve. Nevertheless, in the pump according to the invention, the moving member is disposed such that the reduced pressure in the pumping chamber forces the moving member against the valve seat. In this way, the reduced pressure in the pumping chamber helps the resilient force of the elastomeric head to keep the discharge valve closed, namely, the resilient recovery force and the force due to the reduced pressure in the pumping chamber act in the same direction. In other words, the moving member of the discharge valve has two faces, one of them oriented upstream (the inner face) and the other one oriented downstream (the outer face). Thus, when the discharge valve is closed, the moving member has the face oriented upstream (the inner face) subject to the reduced pressure inside the pumping chamber, while the face oriented downstream (the outer face) is subject to the atmospheric pressure of the environment. Therefore, the pressure differential tends to move the moving member in the upstream direction, pressing it against the valve seat. This improves the closing of the discharge valve, which prevents air from entering the pumping chamber and improves the pumping effect of the pump.

In the present description and claims, it is to be understood that a material having elastomeric properties is any material capable of being subjected to a resilient deformation sufficient to fulfill the requirements of the invention, particularly, capable of generating a pumping effect of a liquid contained in a bottle. Thus, not only must the conventional elastomeric materials be included in this group of materials, but other plastics materials must also be included, such as for example polypropylene, which, with an appropriate geometry, may be subjected to considerable resilient deformation and may recover their initial shape when the external force causing their deformation ceases.

Generally, the partition forming the moving member may have any geometry, either flat, in the form of a cylindrical surface, in the form of a spherical cap, undulated, etc. The only requirement is that the force caused by the pressure difference (reduced pressure in the pumping chamber and atmospheric pressure at the outlet of the discharge valve) should press the partition against the valve seat, which consists basically of a frame against which the perimeter of the partition will bear. Nevertheless, the partition is preferably a flat surface or a cylindrical surface. Specifically, the cylindrical surface allows it to be housed better in the ensemble of the pump, in which the majority of the surfaces in its surroundings are also cylindrical.

A preferred embodiment of the invention is obtained when the partition is a cylindrical surface extending over a certain relatively small angle, generally less than 90° and even less than 45°. Thus, the curved shape of the partition does not make it excessively rigid so that it can move by flexure. Nevertheless another preferred form of the invention is obtained when the partition is a cylindrical surface extending over 360°, i.e. such as to form a cylinder surrounding the second surface. In this case, the discharge valve communicates the pumping chamber with an annular discharge conduit surrounding the entire pumping chamber. In this case the valve seat is preferably formed by a second also cylindrical partition and is disposed in the main body such that the second partition surrounds the first surface. Thus, the partition (which is the moving member of the discharge valve) bears against the second partition (which is the frame or fixed member of the discharge valve) when the discharge valve is closed. When the liquid contained in the pumping chamber is compressed, the cylindrical partition bends totally outwardly allowing the liquid to flow to the annular discharge conduit.

The second surface is advantageously convexly curved towards the exterior of the pumping chamber and preferably is a spherical cap. In fact, this geometry optimizes the pumping chamber for a minimum surface of the head. Furthermore, it has a good resilient recovery force, causing the external actuation surface to return to its original geometry, overcoming the reduced pressure generated inside the pumping chamber. Alternatively it is possible to make the second surface flat. In this case, the external actuating surface of the head does not project above its surroundings, which allows for the design of pumps that, for example, may be piled on the head.

The first surface is advantageously provided with a portion concavely curved towards the interior of the pumping chamber, and it is preferably a spherical portion. As in the case commented above, this geometry optimizes the volume of the pumping chamber with regard to the area thereof. But this geometry is particularly effectively adapted to the shape to be assumed by the second surface when deformed by a finger. Furthermore, it is particularly advantageous for the curved portion and the second surface to make contact in the limit of the stroke followed by the second surface during a pumping movement. In this way the residual volume of the pumping chamber is minimized, whereby the size of the pump may be optimized. It is likewise particularly advantageous for the curved portion to have an outer rim that is convex towards the inside of the pumping chamber. This outer rim serves as a support for the second surface, allowing it to deform more “smoothly”, avoiding the formation of major deformations (and, therefore, major stresses) at the edge of the second surface, i.e. in the portion where the head member which moves and the head member which is attached to the rest of the pump are connected. Furthermore, the outer rim serves to reduce even more the residual volume of the pumping chamber. Finally, it also serves to facilitate the recovery of the second surface to its original position (extended position).

The valve seat preferably has a rounded contact surface with the moving member. This geometry improves the seal between the partition and the valve seat, because when the partition is deformed by the pressure differential between the pumping chamber and the outside, this deformation causes the support surface between the partition and the frame to be increasingly greater, whereby the force tending to close the partition is distributed over a larger area. For the same reason, the moving member advantageously has a contact portion with the valve seat that is increasingly thinner towards its free end.

In the pump according to the invention the head has two members, the external actuation surface with its corresponding second surface and the moving member of the discharge valve defining a partition, which have totally different functions. Nevertheless, the head is an integral unit and is made from an elastomeric material, whereby the deformation undergone by the head during pumping, which should strictly be located on the external actuation surface, may really extend to affecting the moving member of the discharge valve, influencing the closing thereof. It is therefore advantageous for the pump to have at least one column on the first surface extending towards the second surface and disposed in a portion proximate the discharge valve. In fact, in this way the column acts as a stop such that the deformation of the head is stopped by the column and the head portion where the moving member of the discharge valve is disposed is not affected. There are advantageously two columns, such that there is a broad passage between them for the pumped liquid. The columns preferably have such a height that they contact the second surface when the second surface is in its extended position. In this way, immediately the deformation of the external actuation surface starts, the columns perform their support function and the portion of the head where the moving member of the discharge valve is located is not deformed in any way due to the deformation of the external actuation surface.

### BRIEF DESCRIPTION OF THE DRAWINGS

Further advantages and features of the invention will become evident from the following description in which preferred embodiments of the invention are described without any limiting nature, with reference to the accompanying drawings, in which:

FIG. 1 is longitudinal section view of a pump according to the invention, in the open position.

FIG. 2 is a cross section view of the pump of FIG. 1 in the closed position.

FIG. 3 is a longitudinal section view on the line 111-111 of the attachment body of the pump of FIG. 1.

FIG. 4 is an elevation view of the attachment body of FIG. 3.

FIG. 5 is a top plan view of the attachment body of FIG. 3.

FIG. 6 is a bottom plan view of the head of the pump of FIG. 1.

FIG. 7 is a longitudinal section view of the head of FIG. 6.

FIG. 8 is a bottom perspective view of the head of FIG. 6.

FIG. 9 is a longitudinal section view of the main body of the pump of FIG. 1.

FIG. 10 is a front elevation view of the main body of FIG. 9.

FIG. 11 is a top plan view of the main body of FIG. 9.

FIG. 12 is a top perspective view of the main body of FIG. 9.

FIG. 13 is a top perspective view of the pump of FIG. 1 in the open position.

FIG. 14 is a top perspective view of the pump of FIG. 2 in the closed position

FIG. 15 is a longitudinal section view of the pump of FIG. 1 with the second surface deformed.

FIG. 16 is a longitudinal section view of a simplified metering pump.

### DETAILED DESCRIPTION OF EMBODIMENTS OF THE INVENTION

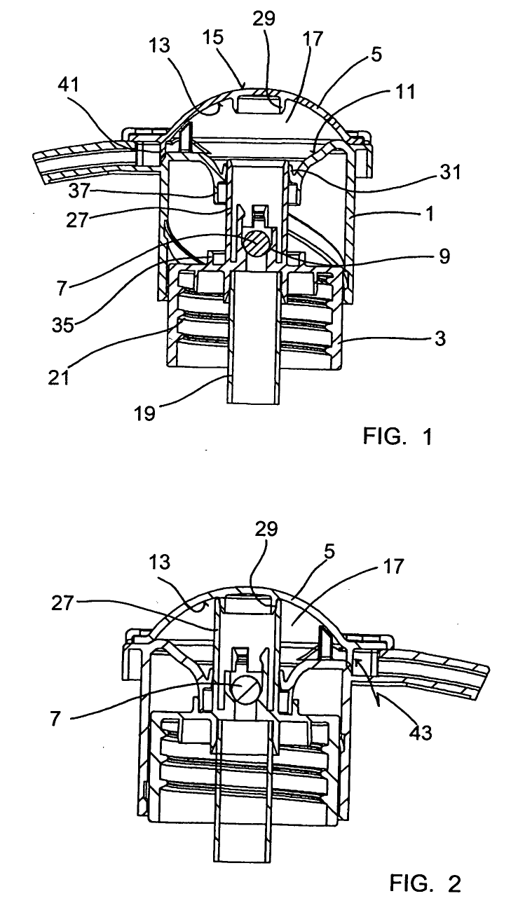

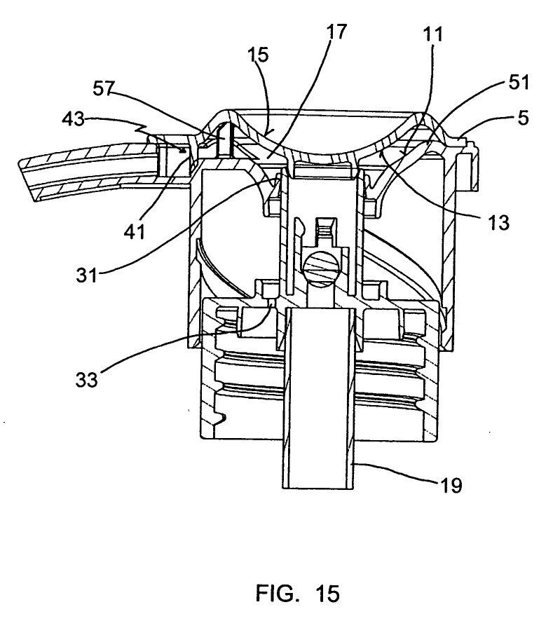

FIG. 1 shows a pump according to the invention, to be precise, a metering pump. It comprises a main body 1, a attachment body 3, a head 5 and a ball 7 which is the moving member of a inlet valve 9 disposed in the attachment body 3. The main body 1 has a first surface 11 facing a second surface 13 disposed in the head 5. Between these two there is defined a pumping chamber 17. The head 5 is made from a material having elastomeric properties and has an external actuation surface 15 adapted to be deformed by a user's finger between an extended position, corresponding to the rest position shown in FIG. 1, and a deformed position, corresponding to the end of pumping position shown in FIG. 15. The external actuation surface 15 coincides substantially with the second surface 13, bearing in mind only that the external actuation surface 15 is the one physically in contact with the outside and with the user's finger and the second surface 13 is the surface facing the inside of the pump, concretely towards the pumping chamber 17.

FIG. 1 also shows a dip tube 19 attached at one end to the attachment body 3 by second attachment means formed substantially by a cylindrical projection adapted to house the dip tube 19 therein. The dip tube 19 has the other end thereof dipped in the liquid to be pumped contained in a bottle, not shown in the drawing.

The attachment body 3 is provided with first attachment means consisting of a threaded portion 21 adapted to be attached to a bottle neck, it is also provided with protrusions 23 housed in helical grooves 25 disposed in the main body 1 so that when the main body 1 is rotated relative to the attachment body 3, apart from the rotary movement there is a translation movement along the longitudinal axis of the pump, whereby there is achieved a relative displacement between the attachment body 3 and the main body 1 between an open position, as shown in FIG. 1, and a closed position, as shown in FIG. 2. The attachment body 3 has, furthermore, a projection in the form of a tubular stem 27 that surrounds the inlet valve 9 and extends along the longitudinal axis towards the head 5.

When the pump is in the closed position the tubular stem 27 is inserted inside the pumping chamber 17 up to touching the head 5, precisely the second surface 13. The second surface 13 is provided with a second cylindrical projection 29 that improves the seal between the second surface 13 and the tubular stem 27. Thus the inlet valve 9 is completely closed such that the liquid contained in the bottle cannot flow through the inlet valve 9 and be poured outside although the inside of the bottle is overpressurized and/or the bottle is placed upside down.

The main body 1 has a first annular lip 31 sealing against the outside wall of the tubular stem 27. In this way, the pumping chamber 17 is sealed without any possibility of the liquid held therein flowing inside the main body 1.

The pump is provided with a ventilation hole 33 disposed in the attachment body 3 allowing air to enter the bottle and replace the pumped liquid. The area of contact between the protrusions 23 and the helical grooves 25 is not hermetic, so that the air can flow inside the main body 1 and inside the bottle through the ventilation hole 33. The attachment body 3 is provided with an annular partition 35 surrounding the ventilation hole 33, and the main body 1 has a second annular lip 37 which seals against the annular partition 35 when the pump is in its closed position. In this way there is prevented possible leaks of the liquid from the bottle through the ventilation hole 33.

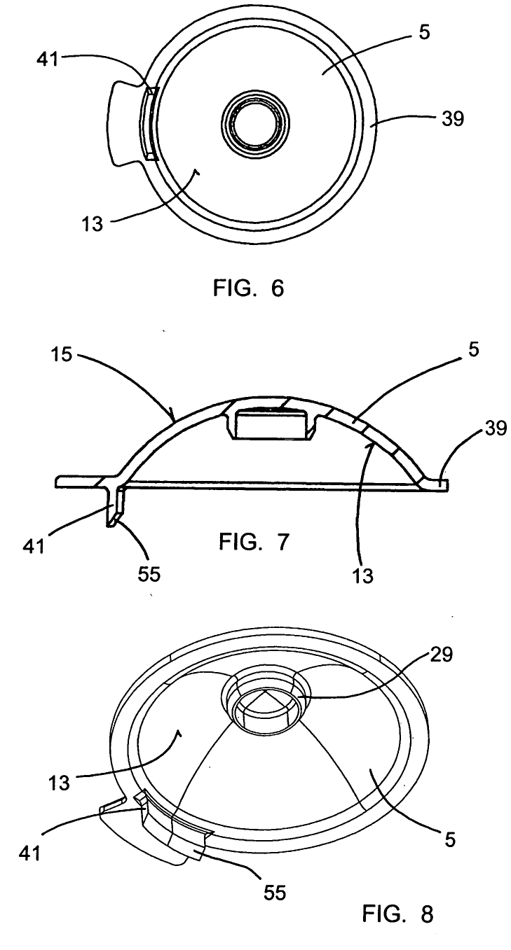

The head 5 is made from a material having elastomeric properties. It comprises a connecting portion 39 with the main body 1. This connection may be by any conventional means, such as welding, adhesive bonding, etc. The head 5 is also provided with a partition 41 that is the moving member of a discharge valve 43. This discharge valve 43 is provided with a valve seat 45 disposed in the main body 1. The partition 41 may be bent resiliently such that it performs an approximate rotary movement around the connecting portion between the partition 41 and the rest of the head 5 between a first position, in which the discharge valve 43 is closed, in which the partition 41 contacts the valve seat 45, and a second position, in which the discharge valve 43 is open, in which the partition 41 has flexed arcuately owing to the pressure of the liquid contained in the pumping chamber 17 (in FIGS. 6 through 8 this would be a flexing to the left).

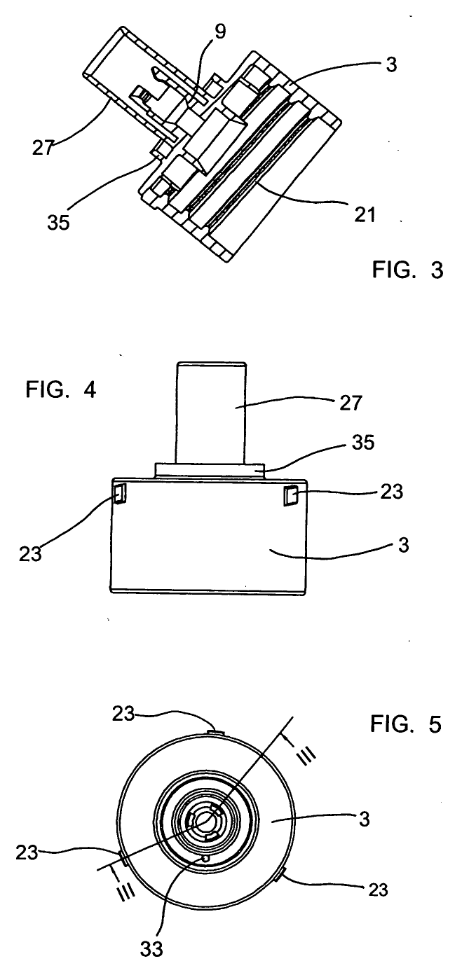

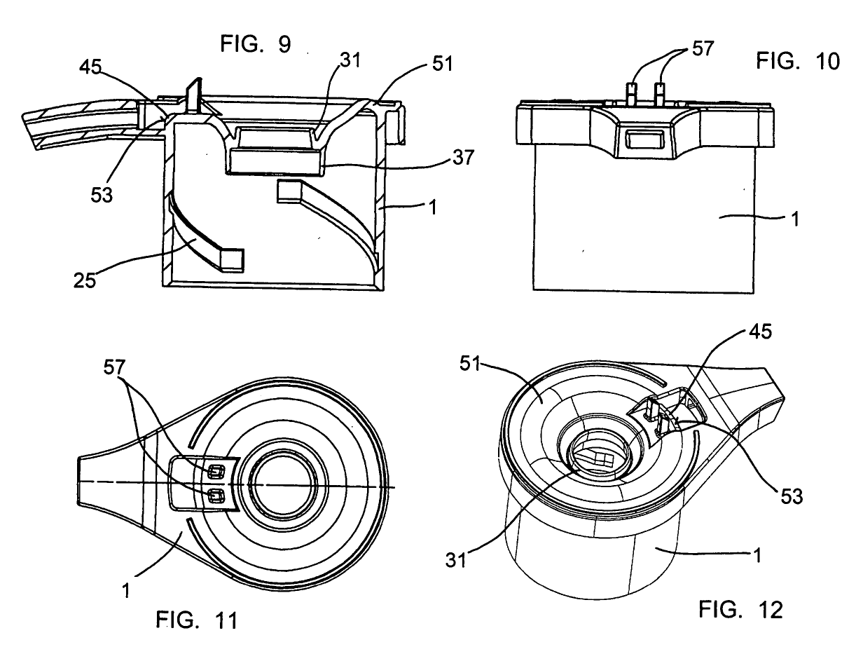

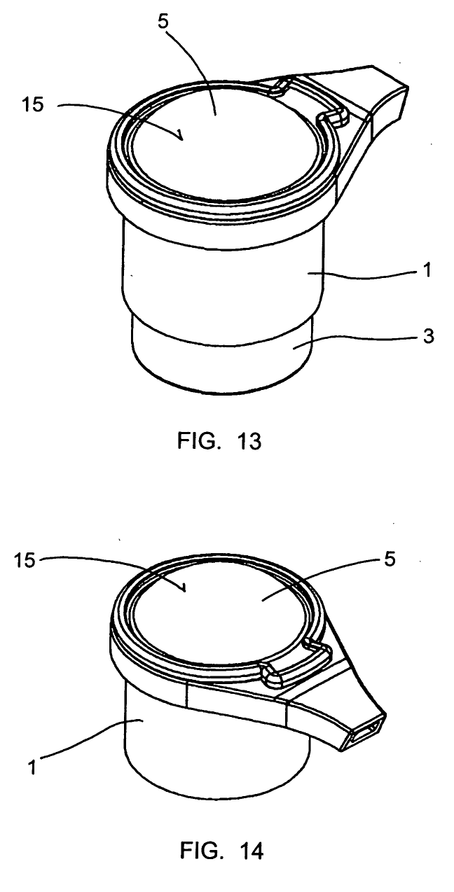

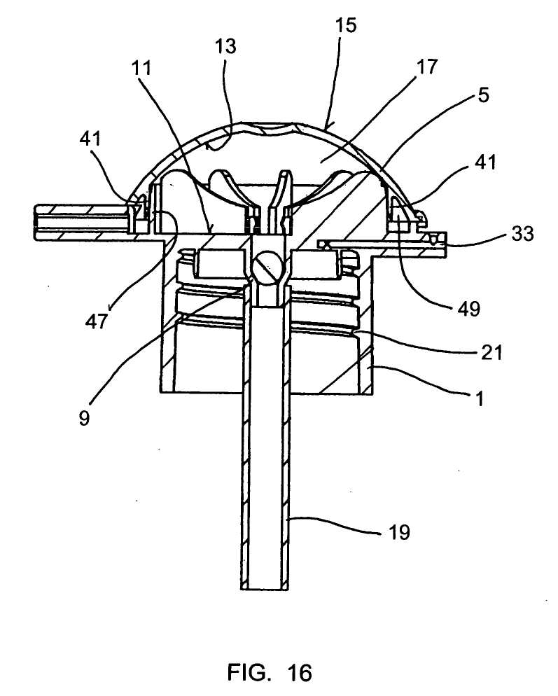

As may be seen, the partition 41 shown in FIGS. 6 through 8 is a cylindrical surface extending over an angle of approximately 30°. Nevertheless, this geometry may be different, as for example the partition 41 may be flat, undulating, or any other geometry. Likewise, its perimeter may be substantially rectangular, but is may adopt other geometries, such as for example, oval. FIG. 16 shows a simplified metering pump in which the partition 41 is a cylinder (i.e. a cylindrical surface which extends over 360°) that completely surrounds the second surface 13. The partition 41 contacts a second partition 47 disposed on the main body 1 and defining the valve seat 45 of the discharge valve 43. The second partition 47 surrounds the first surface 11. In this way the liquid flows out of the pumping chamber in all directions since the discharge valve 43 is annular. At the exit of the discharge valve 43 there is a discharge channel 49, which is also annular, and which leads the pumped liquid to the discharge orifice. Although no sealing mechanism according to the invention has been included in the pump shown in FIG. 16, a man of the art may immediately apply the concept of the sealing mechanism shown in FIGS. 1 through 15 to the pump of FIG. 16. The pump of FIG. 16 has been included mainly to show a possible alternative for the discharge valve 43.

In the examples illustrated in the Figures, the second surface 13 is a spherical cap. Nevertheless, it could also be a flat disc-shaped surface closing the pumping chamber 17. Likewise, the first surface 11 has a portion concavely curved towards the interior of the pumping chamber 17, which is substantially spherical in shape, although here again

it could be flat or have any other geometry. The only basic requirement is that a pumping chamber 17 be defined between the first surface 11 and the second surface 13 when the second surface 13 is in the extended position. Nevertheless, as stated above, the spherical geometries are advantageous. Additionally, the main body 1 has an external rim 51 convex towards the interior of the pumping chamber 17 and surrounding the curved portion of the first surface 11.

The valve seat 45 of the discharge valve 43 has a rounded surface 53 for contacting the partition 41 (which is the moving member of the discharge valve 43). Further, the partition 41 is provided with a portion 55 for contacting the valve seat 45 of the discharge valve 43, concretely with the contact surface 53, the thickness of which tapers down towards its free end. As stated above, these two geometric solutions each improve the sealing of the discharge valve 43.

The pump has two columns 57 projecting from the first surface 11 and extending to practically touching the second surface 13 when the latter is in its extended position. Both columns 57 are disposed at a portion proximate the discharge valve 43. As may be seen in FIG. 15, these columns 57 prevent the head 5 from deforming in the portion proximate the partition 41, namely, in the portion proximate the discharge valve 43. In fact, what the columns 57 do is delimit more clearly which is the external actuation surface 15 and the second surface 13 from what is the discharge valve 43. Thus, when the external actuation surface 15 has been deformed, as shown in FIG. 15, this deformation is prevented from extending to the portion of the partition 41, which could cause incorrect operation of the discharge valve 43.

FIG. 15 also shows how the curved portion of the first surface 11 and the second surface 13 extend almost mutually parallel to each other. With an appropriate design, it is possible to achieve that these two surfaces make contact, whereby it is possible to minimize the residual volume of the pumping chamber 17.

As may be seen in the pump example shown in FIG. 15, the second cylindrical projection 29 of the second surface 13 practically makes contact with the upper end of the tubular stem 27, when the pump is in the open position and the second surface 13 is in the deformed position. One preferred embodiment of the invention is obtained when the relative displacement effected by the upper end of the tubular stem 27 when moving between the closed position and the open position is greater than the relative movement effected by the second cylindrical projection 29 on moving the second surface 13 between the extended position and the deformed position. In this way, when the pump is in the open position, the second cylindrical projection 29 is prevented from contacting the upper end of the tubular stem 27, thereby reducing the risk of the second cylindrical projection 29 becoming jammed in the upper end of the tubular stem 27 during a pumping movement.

In the embodiments shown, the partition 41 is always close to the end of the external actuation surface 15 (which is a spherical cap). Nevertheless, it is not necessary for this to be so, but, for example, the part of the head 5 and of the main body 1 corresponding to the discharge valve 43 could extend towards the discharge tube such that the partition 41 is further separated from the pumping chamber 17 (for example, half way between the position it occupies in FIG. 1 and the discharge orifice). This would allow the effect of the deformation of the external actuation surface 15 on the partition 41 to be reduced also. Not shown either in the drawing figures is an example of a pump according to the invention based on a spray pump such as the one shown in ES P9800915. Nevertheless, a man of the art may easily appreciate that the concept of the sealing mechanism shown in the figures may be carried over to a spray pump, particularly to a spray pump such as the one shown in ES P9800915. These pumps habitually comprise a shell and a piston defining a pumping chamber. The shell is fixed to the bottle containing the liquid to be contained and the piston moves attached to a head. By simply including an attachment body such as the one claimed and, for example, a helical displacement mechanism between the attachment body and a main body (comprising the remaining components of the original shell), a pump according to the invention may be obtained, The projection of the attachment body may again be a tubular stem surrounding the inlet valve and forming a seal with the bottom surface of the piston or the plug member.

1. A pump having a sealing mechanism comprising: (a) a main body having a first surface, (b) a attachment body having first means for attachment to a bottle neck, (c) second means for attachment of a dip tube, (d) an inlet valve, (e) a second surface facing said first surface, where said first surface and said second surface define a pumping chamber, and (f) a discharge valve at an outlet of said pumping chamber (17), where said first surface and said second surface are adapted to perform a relative movement therebetween causing the pumping of a liquid between said inlet valve and said discharge valve, wherein said attachment body is attached to said main body for relative displacement between an open position and a closed position and wherein said attachment body includes a projection which, when said attachment body and said main body are in said closed position, prevents said second surface from performing said relative movement.

2. The pump of claim 1, wherein said projection is a tubular stem surrounding said inlet valve.

3. The pump of claim 2, wherein said projection is hermetically sealed against said second surface when said attachment body and said main body are in said closed position.

4. The pump of claim 1, wherein said relative displacement is greater than said relative movement.

5. The pump of claim 2, wherein said main body comprises a first annular lip forming a hermetic seal with the outer wall of said tubular stem.

6. The pump of claim 5, wherein said main body comprises a second annular lip forming a hermetic seal with an annular partitions disposed in said attachment body, said annular partitions surrounding a ventilation hole.

7. The pump of claim 1 further comprising: (a) a head, where said head (5) includes said second surface, where said head is made from a material having elastomeric properties adapted to be resiliently deformed by a manually applied force and has an external actuation surface adapted to be deformed by a user's finger, (b) said discharge valve includes a valve seat and a moving member adapted to move between a first position, corresponding to said closed discharge valve and in which said moving member contacts said valve seat, and a second position, corresponding to said open discharge valve (43), where said moving member extends from said head forming a partition, where said moving member is integral with said head, and (c) when said moving member is in said first position, and there is a reduced pressure in said pumping chamber, said reduced pressure then exerts a force pressing said moving member against said valve seat.

8. The pump of claim 7, wherein said partition is a flat surface.

9. The pump of claim 7, wherein said partition is a cylindrical surface.

10. The pump of claim 7, wherein said partition is a cylinder surrounding said second surface.

11. The pump of claim 7, wherein said valve seat is formed by a second partitions disposed in said main body, where said second partition (47) surrounds said first surface.

12. The pump of claim 7, wherein said second surface is convexly curved towards an outside of said pumping chamber,and is a spherical cap.

13. The pump of claim 7, wherein said first surface has a concavely curved portion towards the interior of said pumping chamber, and is a spherical portion.

14. The pump of claim 13, wherein said curved portion and said second surface make contact in a limit of the stroke followed by said second surface during a pumping movement.

15. The pump of claim 13, wherein said curved portion has an external rim that is convex towards an interior of said pumping chamber.

16. The pump of claim 7, wherein said valve seat has a rounded contact surface with said moving member.

17. The pump of claim 7, wherein said moving member has a contact portion with said valve seat having a thickness tapering down towards a free end thereof.

18. The pump of claim 7, having at least one columns on said first surface extending towards said second surface and which is disposed at a portion proximate said discharge valve.

19. The pump of claim 18, wherein said at lest one column has a height such as to contact said second surface when said second surface is in an extended position thereof.
